(19) United States
(12) Patent Application Publication
(10) Pub. No.: US 2008/0203672 A1
(43) Pub. Date: Aug. 28, 2008

(54) PRESSURE-ENERGIZED SHAFT SEAL

(75) Inventor: Robert E. Smith, Missouri City, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: NATIONAL COUPLING COMPANY, INC., Stafford, TX (US)

(21) Appl. No.: 11/680,158

(22) Filed: Feb. 28, 2007

(51) Int. Cl. B61F 15/22; F16J 15/34

(52) U.S. Cl. 277/356; 277/366; 285/111

(57) ABSTRACT

A generally cylindrical shaft seal with an axial opening is disclosed having annular “lips” or “legs” on one or both ends that are separated by a fluid-filled cavity. The seal is adapted to seal between a support or housing holding the seal and a generally cylindrical shaft passing axially through the seal. Fluid, under pressure, may enter the cavity and urge the lips or legs in a radial direction which enhances the sealing engagement of the seal member to the shaft and the housing. In certain embodiments, the seal has a concave inner surface to minimize the contact area (and hence the friction) between the seal and the movable shaft. The outer circumference of the seal may be equipped with one or more O-ring seals for sealing to the housing or support. The seal may be fabricated from natural or synthetic polymers, metal or composite materials.

### CROSS-REFERENCE TO RELATED APPLICATIONS

None

### BACKGROUND OF THE INVENTION

1. Field of the Invention

This invention relates to seals. More particularly, it relates to pressure-energized seals for rotating and/or reciprocating shafts.

2. Description of the Related Art

U.S. Pat. No. 6,179,002 discloses an undersea hydraulic coupling having a radial pressure-energized seal with a dovetail interfit. The seal has a pair of flexible sealing surfaces for sealing with the male and female coupling members, and a cavity therebetween that is exposed to fluid pressure in the coupling. The outer circumference of the seal has a dovetail interfit between inclined shoulders in the female member bore and on a seal retainer that holds the seal in the bore. The dovetail section acts to prevent radial movement of the seal into the bore of the female member when the male coupling member is withdrawn.

U.S. Pat. No. 5,355,909 discloses an undersea hydraulic coupling having a pair of hollow metal seals which are pressure energized to seal between the male and female members of the coupling. One of the hollow metal seals is configured to expand radially while the second hollow metal seal is compressible along the longitudinal axis of the coupling. These seals provide a fluid tight sealing arrangement upon pressurization of the coupling, without the need for external pre-load devices.

U.S. Pat. No. 5,339,861 discloses an undersea hydraulic coupling with a hollow metal O-ring seal for sealing between the male and female members. The hollow metal O-ring seal is held captive between an internal shoulder and a retainer insertable into the internal bore of the female member. The retainer may be slidable to compress the metal o-ring seal axially. The metal O-ring seal may be pressure-energized to expand the seal cavity in response to fluid pressure in the coupling.

U.S. Pat. No. 5,277,225 discloses an undersea hydraulic coupling having a pair of flexible, pressure-energized seals. The seals are configured to seal radially between the male and female members of the coupling so that hydraulic fluid does not leak from the annular space between the receiving chamber and outer surface of the male member. The coupling is pressure-balanced for fluid communication through mating radial passages and the annular space between the members.

U.S. Pat. Nos. 5,203,374 and 5,099,882 disclose a pressure-balanced hydraulic coupling for use in undersea drilling and production operations, the coupling having radial passageways communicating between the male and female members such that substantial fluid pressure is not exerted against the face of either member during coupling or uncoupling or during the coupled state. Mutually opposed valve actuators contact one another to effectuate the simultaneous opening of check valves, and allow fluid to flow through a valve port and then radially through matching fluid passageways in the male and female members. The radial passageways of the male and female members match up at their longitudinal surfaces so that fluid pressure between the male and female members is in a substantially radial direction and is not exerted at the face of either member. A first pair of seals is positioned on each side of the radial passage for sealing between the receiving chamber and the seal retainer. A second pair of seals is positioned on each side of the radial passage for sealing between the seal retainer and the male member. The seals are pressure-energized metal seals.

U.S. Pat. No. 4,854,615 discloses a joint for forming a sealed junction between two large diameter cylinders or rocket motor casings. A tongue-and-groove arrangement employs a pressure-energized metal seal which expands radially when the cylinders are internally pressurized. The radial expansion enhances the sealing effect of the metal seal between the tongue and the groove. The metal seal is capable of withstanding extreme pressures and temperatures which can adversely affect the sealing capability of elastomer O-rings.

### BRIEF SUMMARY OF THE INVENTION

A seal having “lips” or “legs” separated by a fluid-filled cavity is adapted to seal between a support or housing holding the seal and a generally cylindrical shaft passing axially through the seal. Fluid, under pressure, may enter the cavity and urge the lips or legs in a radial direction which enhances the sealing engagement of the seal member to the shaft and the housing. The seal may have a concave inner surface to minimize the contact area (and hence the friction) between the seal and the movable shaft. The outer circumference of the seal may be equipped with one or more O-ring seals for sealing to the housing or support.

### BRIEF DESCRIPTION OF THE SEVERAL VIEWS OF THE DRAWING(S)

FIG. 1 is a partially cross-sectioned view of a seal according to the present invention in use on a reciprocating shaft.

FIG. 2 is a partially cross-sectioned view of a seal according to the present invention mounted in a journal box and in use on a rotating shaft.

FIG. 3 is an enlarged view of the seal section of the apparatus illustrated in FIG. 1.

FIG. 4 is a view, partially in cross-section, of a second embodiment of the invention.

FIG. 5 is a view, partially in cross-section, of a third embodiment of the invention.

FIG. 6 is a cross-sectional view of the seal depicted in FIGS. 1-3.

### DETAILED DESCRIPTION OF THE INVENTION

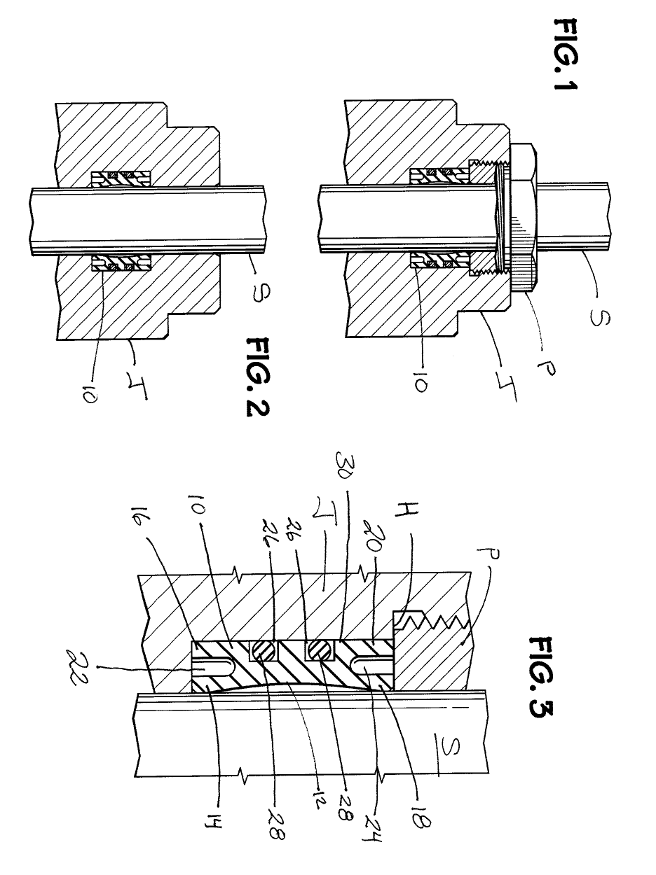

In the embodiment shown in FIG. 1, seal 10 of the present invention is held in a housing or support J by threaded packing nut P. Housing J may be one end of an hydraulic cylinder. Reciprocating shaft S (which may be, for example, an hydraulic ram) passes through the central axial passage of seal 10 and the packing nut P. Seal 10 is in sealing engagement with housing J and shaft S. The packing nut (retaining member) may have a threaded outer circumference that engages a threaded opening in support J. However, the retainer member may engage the housing or support by other means; for example, the seal retainer may be slidingly inserted into the housing and held in place with a clip. Shoulder H may be provided in the bore of housing J to limit the amount of axial compression applied to seal 10 when nut P is fully seated.

Optionally, the outer circumference 38 of seal 10 may include one or more O-rings 28 in one or more annular grooves 26 which seal between the body of seal 10 and support or journal box J.

The inner radial circumference of seal 10, according to a first embodiment depicted in FIGS. 1-3, includes a pair of opposing, pressure-energized sections for sealing engagement with a reciprocating or rotating shaft S. Leg or lip section 14 engages the shaft while leg or lip section 16 of the seal engages the inner surface of recess 30 in housing J. Fluid pressure acting on cavity 22 urges the lip or leg sections 14 and 16 radially against the shaft and housing respectively to pressure energize the seal, especially at higher pressures. As the pressure acting on cavity 22 increases, the sealing pressure is enhanced. Before engagement of the lip or leg section 14 with shaft S, the lip or leg section 14 may extend slightly radially into the bore to preload the seal with an interference fit against shaft S. Alternatively, the seal may rely entirely on pressure energization of the seal rather than preloading or interference fit with the shaft.

Seal 10 also includes an opposing pair of lip or leg sections 18, 20, with an intermediate cavity 24. This portion of the seal may also be pressure energized to urge the lip or leg sections 18 or 20 inwardly and outwardly to enhance the seal. Providing seal 10 with a lateral axis of symmetry prevents seal 10 from being installed upside down.

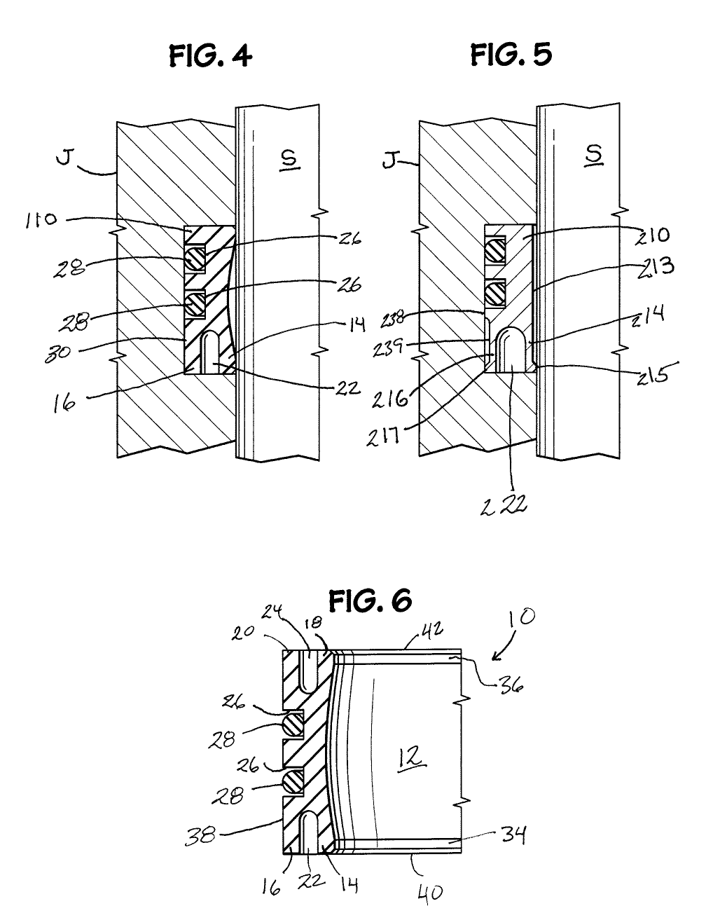

Now referring to FIG. 4 of the drawing, in a second preferred embodiment the polymeric seal 110 has lip or leg sections 14, 16 with an intermediate cavity 22 that is pressure energized to enhance the seal by urging the lip or leg sections radially inwardly or outwardly. A pair of O-rings 28 may also be included to seal with housing or support J. This embodiment is particularly suited for applications in which the end of seal 110 having leg sections 14 and 15 is exposed to higher fluid pressures than the opposing end of seal 110.

A third embodiment of the present invention particularly preferred for relatively hard seal materials such as metals and machineable plastics is shown in FIG. 5. Seal 210 has outer cylindrical surface 238 and inner cylindrical surface 213. Outer circumference 238 may have section 239 of reduced diameter to provide more flexibility to leg 216. Surface 213 may be flat. Groove 222 may be of larger width than groove 22 in the first and second embodiments so that legs 214 and 216 will be thinner and hence more flexible. This thinness is particularly preferred for harder and more rigid seal materials. The outer cylindrical surface 238 may include one or more circumferential grooves 26 for O-rings 28 which seal with the support or journal box holding the seal. The inner circumference of seal 210 includes lip or leg sections 214, 216 with pressure-energized expansible cavity 222 therebetween. Cavity 222 may be pressure energized to urge the lip or leg sections 214, 216 radially outwardly and inwardly to seal with shaft S and journal box J. Legs 214 and 216 may have projections 217 and 215 to concentrate the sealing pressure in a smaller area. The seal 210 may be configured to have a slight radial interference fit with the shaft S, such that lip or leg section 214 (or projection 215) extends slightly into the bore of the journal box, thereby preloading the seal. Alternatively, seal 210 may be configured to require only fluid pressure acting on cavity 222 to effect the seal with the shaft.

FIG. 6 depicts an uninstalled seal 10 according to the first embodiment (FIGS. 1-3) of the invention. The seal is symmetric about its longitudinal axis and hence only one side is illustrated. It may be seen that concave inner surface 12 of seal 10 may have seal contact area 34 proximate end 40 and seal contact area 36 proximate end 42. Contact areas 34 and 36 may comprise relatively flat regions of otherwise concave inner surface 12. The height of contact areas 34 and 36 may be chosen to achieve the seal pressure desired per unit area. For example, for a given fluid pressure in cavity or groove 22, the sealing pressure per unit area will be increased by decreasing the height of contact area 34. Concave surface 12 prevents excessive contact between seal 10 and shaft S thereby reducing friction between these two elements.

Seals according to the present invention may be fabricated from any suitable material. Examples of seal material include natural and synthetic polymers including, but not limited to rubber and other elastomers (e.g., styrene-butadiene, polybutadiene, neoprene, nitriles and fluoroelastomers such as VITON™), fluorocarbon polymers such as tetrafluoroethylene (TFE, TEFLON™) and fluorinated ethylene-propylene (FEP) resins, acetal resins (DELRIN™), polyetheretherketone (PEEK), polyamide polymers (e.g, nylon), polyurethanes, silicones, as well as various metals or alloys including plated metals. Seals may also be fabricated from composite materials such as fiber-filled or fiber-reinforced plastics.

In general, seals of softer materials may be formed by molding or extrusion while seals of harder materials may be machined.

Although the invention has been described in detail with reference to certain preferred embodiments, variations and modifications exist within the scope and spirit of the invention as described and defined in the following claims.

What is claimed is:

1. A shaft seal comprising:
a generally cylindrical body having a first end, a second end opposite the first end, and a central axial passage sized to accommodate a cylindrical shaft; and,
an annular groove in the first end of the body defining an inner leg adjacent the axial passage and an outer leg forming at least a portion of the outer circumference of the body, the groove sized and spaced such that a fluid, under pressure in the groove, will urge the inner leg in an inward radial direction.

2. A shaft seal as recited in claim 1 wherein the body has a concave wall defining the central axial passage.

3. A shaft seal as recited in claim 1 further comprising an annular groove in the second end of the body defining a second inner leg adjacent the axial passage and a second outer leg forming at least a portion of the outer circumference of the body, the groove sized and spaced such that a fluid, under pressure in the groove, will urge the inner leg in an inward radial direction and urge the outer leg in an outer radial direction.

4. A shaft seal as recited in claim 1 further comprising an annular groove on the outer circumference of the body.

5. A shaft seal as recited in claim 4 further comprising an O-ring in the annular groove.

6. A shaft seal as recited in claim 1 further comprising a plurality of annular grooves on the outer circumference of the body.

7. A shaft seal as recited in claim 6 further comprising an O-ring in each of the annular grooves.

8. A shaft seal as recited in claim 1 wherein the cylindrical body is fabricated from a material selected from the group consisting of natural polymers, synthetic polymers, rubber, styrene-butadiene, polybutadiene, neoprene, nitriles, fluoroelastomers, fluorocarbon polymers, acetal resins, polyetheretherketone, polyamide polymers, nylon, polyurethanes, silicones, metals, metal alloys, plated metals and fiber-reinforced plastics.

9. A shaft seal as recited in claim 1 wherein fluid pressure in the groove urges the outer leg in an outer radial direction.

10. A shaft seal as recited in claim 1 further comprising a radial projection on the inner surface of the inner leg.

11. A shaft seal as recited in claim 10 wherein the radial projection has an inner diameter smaller than the cylindrical shaft such that insertion of the shaft preloads the seal.

12. A journal box comprising:
a first body having a generally cylindrical bore extending from a first end to a second end of the body;
an annular recess in the wall of the cylindrical bore; and,
a shaft seal mounted in the annular recess comprising a generally cylindrical second body sized to fit within the annular recess and having a first end, a second end opposite the first end, and a central axial passage sized to accommodate a cylindrical shaft and an annular groove in the first end of the second body defining an inner leg adjacent the axial passage and an outer leg forming at least a portion of the outer circumference of the second body, the groove sized and spaced such that a fluid, under pressure in the groove, will urge the inner leg in an inward radial direction.

13. An hydraulic actuator comprising:
a cylinder having a first end and a second end;
a piston within the cylinder;
a shaft connected to the piston and extending through the first end of the cylinder; and,
a shaft seal mounted in the first end of the cylinder and comprising a generally cylindrical body having a first end, a second end opposite the first end, and a central axial passage sized to accommodate the shaft and an annular groove in the first end of the body defining an inner leg adjacent the axial passage and an outer leg forming at least a portion of the outer circumference of the second body, the groove sized and spaced such that a fluid, under pressure in the groove, will urge the inner leg in an inward radial direction.
